(19) United States
(12) Patent Application Publication
(10) Pub. No.: US 2018/0001515 A1
(43) Pub. Date: Jan. 4, 2018

(54) METHOD FOR PRODUCING AN INJECTION-MOLDED PRODUCT, CORRESPONDING INJECTION-MOLDED PRODUCT, AND USE OF ESPECIALLY PREPARED SUNFLOWER HULL FIBERS AS AN ADDITIVE

(71) Applicant: SPC SUNFLOWER PLASTIC COMPOUND GMBH, Garrel (DE)

(72) Inventors: Ulrich MEYER, Garrel (DE); Sebastian MEYER, Hemer (DE); Reinhard TRUMME, Dinklage (DE)

(73) Assignee: SPC SUNFLOWER PLASTIC COMPOUND GMBH, Garrel (DE)

(21) Appl. No.: 15/546,379

(22) PCT Filed: Jan. 26, 2016
(86) PCT No.: PCT/EP2016/051601

§ 371 Date: Jul. 26, 2017

(30) Foreign Application Priority Data
Jan. 27, 2015 (DE) 10 2015 201 386.3

(51) Int. Cl. B29B 15/08; B29C 45/40; B29C 45/00; B29B 7/90; B29K 23/00; B29K 67/00; B29K 101/12; B29K 311/10

(52) U.S. Cl. CPC B29B 15/08; B29C 45/0001; B29C 45/0005; B29C 45/40; B29B 7/90; B29K 2023/06; B29K 2067/046; B29K 2101/12; B29K 2311/10; B29K 2995/004; B29K 2023/12

(57) ABSTRACT

A method for producing an injection-molded product is provided, where sunflower hulls are processed into sunflower hull fibers at a maximum temperature T_{PFmax} of less than 200° C. Then an injection-moldable composite material is produced by mixing the sunflower hull fibers with a plastic material at a maximum temperature T_{PCmax} ofless than 200° C. Next the produced injection-moldable composite material is automatically injection-molded into an injection-molding tool such that a molded composite material is produced. The composite material introduced into the injection-molding tool has a temperature T_{IM} of more than 200° C. in at least one section of the injection-molding tool. Then the molded composite material is removed such that the injection-molded product is produced. A corresponding injection-molded product and the use of especially prepared sunflower hull fibers as an additive are also provided.

The present application claims priority from International Patent Application No. PCT/EP2016/051601 filed on Jan. 26, 2016, which claims priority from German Patent Application No. 10 2015 201 386.3 filed on Jan. 27, 2015, the disclosures of which are incorporated herein by reference in their entirety.

### FIELD OF THE INVENTION

It is noted that citation or identification of any document in this application is not an admission that such document is available as prior art to the present invention.

The present invention relates to a method for producing an injection molded product, to a corresponding injection molded product (which is producible by the method according to the invention) and to the use of specially produced sunflower hull fibers as an additive in an injection moldable composite material.

Injection molding methods belong to the most frequently used methods for the production of products made of plastics material or plastics material composites. Injection molding typically involves plasticizing plastics material or composite granulates by heating. To this end the respective granulate is typically filled into an injection unit of an injection molding machine which comprises a screw and a barrel. In thermoplastics injection molding the barrel is heated so that the granulate is conveyed in the direction of an injection mold by means of the screw and also plasticized inside the injection unit. The plasticized plastics material or composite material leaves the injection unit through a die which forms the transition to the injection mold. This causes a further temperature increase inside the plasticized material on account of shear forces. For a detailed description of customary injection molding machines and the technical component parts thereof reference is made to the technical literature.

The cooled and demolded product of an injection molding method is an injection molded product, the manufacturing accuracy of which depends on various parameters. Control of the cooling processes and choice of the employed plastics material in particular are decisive for manufacturing accuracy because plastics materials and composite materials undergo shrinkage of varying severity depending on the cooling rate. That is to say that molded composite materials produced by injection molding or molded materials made of plastics materials undergo a volume change without a need for removal of material or application of pressure. The phenomenon of shrinkage applies here in particular to semicrystalline plastics materials. It is generally the case that upon relatively slow cooling the molecules of the material molded in the injection mold fit into a comparatively small volume particularly well, while on a rapid cooling this ability is reduced so that more severe shrinkage results for relatively slow cooling than for rapid cooling. In the shaping of products based on composite materials or plastics materials the phenomenon of shrinkage is frequently considered even when designing the injection mold. Those skilled in the art pay particular attention to thick-walled regions of a product because particularly in such thick-walled regions (regions of material accumulation) significant volume contractions, i.e. sink marks, may occur.

Reference is made to the prior art documents WO 2013/072 146 A1 and WO 2014/184 273 A1.

It has hitherto often been attempted to counteract the formation of sink marks and other product defects resulting from the phenomenon of shrinkage by choosing a particularly high packing pressure and a high packing time. Packing pressure may also be referred to as holding pressure and packing time as holding pressure time.

In frequently employed semicrystalline plastics materials such as polypropylene and polyethylene the degree of shrinkage is typically 1.5% to 2%. Since such a degree of shrinkage is generally unacceptable, attempts are made to counteract the shrinkage in the manner recited above and/or by addition of additives such as fillers (e.g. CaCO3 or talc) for example. Proceeding in this way generally results in other disadvantages, for example increased machine wear as a result of the mentioned mineral fillers or long cycle times as a result of longer holding pressure times (packing times) and associated higher component part costs. Yet, the cost and complexity associated therewith is often very great and does not even reliably lead to results accepted by the consumer.Accordingly, for certain applications plastics materials exhibiting only a particularly low shrinkage behavior, or composite materials based on such plastics materials, are employed; available in this regard in particular are the so-called amorphous plastics materials, among which acrylonitrile-butadiene-styrene (ABS) is often preferred. There is an enduring need for measures, formulations and the like which result in low-shrinkage injection molded products.

### SUMMARY OF THE INVENTION

It is accordingly a primary object of the present invention to specify a method for producing an injection molded product which contributes to the produced injection molded product undergoing shrinkage to only a small extent and preferably not at all.

The method to be specified should preferably be independent of the chosen plastics material, but due to the particular challenges associated with the use of semicrystalline plastics materials the method should preferably be suitable for producing low-shrinkage injection molded products based on such semicrystalline plastics materials.

The method to be specified should preferably also make it possible to ameliorate or prevent problems which result from so-called sink marks in injection molded products.

It is a further object of the present invention to specify a corresponding injection molded product.

Finally, it is likewise a further object of the present invention to specify particularly suitable additives which may be employed as a constituent of an injection moldable composite material and whose function it is to reduce shrinkage in automatic injection molding of such a composite material in an injection mold.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

The primary object of the present invention is achieved by a method for producing an injection molded product, comprising the steps of:
(a) processing sunflower hulls to afford sunflower hull fibers at a maximum temperature T_{PFmax} of less than 200° C.,
(b) producing an injection moldable composite material by mixing the sunflower husk fibers produced in step (a) with a plastics material at a maximum temperature T_{PCmax} of less than 200° C.,
(c) automatically injection molding the produced injection moldable composite material into an injection mold to afford a molded composite material, wherein the composite material introduced into the injection mold has a temperature T_{IM} of greater than 200° C. in at least one section of the injection mold,
(d) demolding the molded composite material to afford the injection molded product.

The use of sunflower hull fibers as an additive for specific plastics materials is already known from the document WO 2014/184273 A1 which also discloses an injection molding method.

The document WO 2013/072146 A1 already discloses the use of injection molding of biomaterials or biocomposites based on sunflower seed shells/husks. Plastics materials may be compounded with said sunflower seed shells/husks. The document also discloses the use of specific plastics materials.

The recited documents WO 2013/072146 and WO 2014/184273 do not relate to the problem of shrinkage of injection molded products and do not specify any measures which could be taken in relation to the respectively disclosed injection molding materials to avoid or reduce shrinkage.

It has been found in the applicant's own investigations that, surprisingly, with suitable pretreatment sunflower hull fibers may be mixed as an additive with a plastics material such that during automatic injection molding said fibers have the effect that the resulting injection molded product is subject to only low and thus acceptable shrinkage. It has proven essential in this regard that the sunflower fibers are produced from sunflower hulls at a temperature of below 200° C. so that constituents of the sunflower fibers remain intact during the processing procedure which even at a temperature of just above 200° C. would be decomposed to form gaseous products.

Step (a) of the method according to the invention relates to processing sunflower hulls to afford sunflower hull fibers at a maximum temperature T_{PFmax} of less than 200° C.; a maximum temperature T_{PFmax} of 150° C. is preferred, a maximum temperature T_{PFmax} of 100° C. is particularly preferred.

The sunflower hull fibers resulting in step (a) of the method according to the invention (as a result of the processing of sunflower hulls) thus comprise intact constituents which at a temperature of just above 200° C. would be decomposed and liberate gases. It is a substantial achievement of the present invention to have recognized that this potential of sunflower hull fibers (decomposition of constituents to liberate gases) may be utilized to reduce the shrinkage of corresponding plastics products.

It has been found in the applicant's own investigations that sunflower hull fibers may readily be dried at temperatures of below 200° C. (which is often desired), but that the constituents of the sunflower hull fibers (presumably in particular the lignin-containing constituents) do not significantly decompose at a temperature of below 200° C. The applicant's own investigations have additionally shown that, surprisingly, at a temperature of 200° C. or more an irreversible decomposition of constituents of sunflower hull fibers takes place, which results in the liberation of gases on a considerable scale.

According to step (b) of a method according to the invention, an injection moldable composite material is produced by mixing the sunflower hull fibers produced in step (a) (i.e. the sunflower hull fibers produced under gentle conditions and comprising constituents which may be decomposed even at a temperature of just above 200° C.) with a plastics material. According to step (b) of the method according to the invention it is ensured here that the mixing is effected at a maximum temperature T_{PCmax} of less than 200° C. A maximum temperature T_{PCmax} of 190° C. is preferred, a maximum temperature T_{PCmax} of 170° C. is particularly preferred.

Thus it is avoided not only in step (a) but also during mixing of the sunflower hull fibers with the plastics material and thus in the production of the injection moldable composite material that constituents of the sunflower hull fibers are decomposed to form gases to a significant extent. The potential of the sunflower hull fibers to liberate gaseous decomposition products is accordingly also retained in method step (b) according to the invention.

In step (c) of the method according to the invention the produced injection moldable composite material is automatically injection molded into an injection molding material to afford a molded composite material. According to the invention, in a deliberate departure from the procedure in steps (a) and (b) a higher temperature is now established so that the composite material introduced into the injection mold has a temperature T_{IM} of greater than 200° C., preferably of greater than 220° C., in at least one section of the injection mold (preferably in a plurality of sections). In a method according to the invention such a temperature is often achieved during injection into the injection mold by the action of shear heat on the plasticized composite material already preheated in the injection unit. On account of the temperature T_{IM} of greater than 200° C. (preferably of greater than 220° C.) established in method step (c) in at least one section of the injection mold, the lignin-containing constituents now decompose there to form decomposition gases which are embedded as bubbles in the molded composite material and thus fill part of the internal volume of the injection mold. During cooling and solidification of the molded composite material the bubbles consistently remain included in the solidified composite material. In this way the above-described phenomenon of shrinkage of the molded composite material is counteracted. Based on a predetermined injection mold and a predetermined plastics material, a person skilled in the art will determine using very few preliminary tests the amounts of prepared sunflower hull fibers required to prevent shrinkage completely or to the desired extent.

In step (d) of the method according to the invention the molded composite material is demolded to afford the injection molded product. The injection molded product produced according to the invention exhibits only slight shrinkage, in particular compared to an injection molded product produced under otherwise identical process conditions using sunflower hull fibers obtained from sunflower hulls at a maximum temperature of more than 200° C.

Injection molded products produced by the method according to the invention have the particular feature that they exhibit at most only weakly apparent sink marks, if any, even in the region of thick-walled parts. Compared to injection molded products obtained for comparison in otherwise identical fashion but using sunflower hull fibers obtained from sunflower hulls at a temperature of greater than 200° C., the injection molded products according to the invention have a lower component part weight on account of the proportion of bubbles in the product. The strength of the injection molded products produced by the method according to the invention is consistently not compromised. Since the decomposition of the decomposable constituents of the sunflower hull fibers is temperature-dependent and proceeds independently without further measures in the injection mold, the method according to the invention can produce injection molded products with shorter cycle times. This is because it is not necessary to observe time-consuming holding pressure times or residual cooling times such as have hitherto been customary in particular in the production of thick-walled parts since the decomposing constituents of the sunflower hull fibers bring about a material internal pressure which counteracts shrinkage.

It has been found in the applicant's own investigations that the hitherto customary procedure for preparing dry sunflower hull fibers, where starting from sunflower hulls a grinding and drying are performed, which is associated with temperatures of markedly above 200° C., the method according to the invention achieves markedly better results in terms of the abovementioned aspects. In particular the shrinkage of the resulting injection molded product is lower, the cycle time can be reduced and the component part weight is reduced while retaining strength. The inventors of the present invention have recognized that the choice of a comparatively low processing temperature is advantageous when sunflower hull fibers for use in an injection molding method are to be produced. They have thus departed from the hitherto prevailing view that the composition (in particular in terms of chemistry) of the sunflower hull fibers is not relevant for the following method steps.

It is preferable when in the method according to the invention the difference ΔT between the temperature T_{IM} and the higher of the two temperatures T_{PFmax} and T_{PCmax} is greater than 20° C., preferably greater than 40° C.

The term T_{PFmax} is to be understood as meaning the maximum temperature of the sunflower hull fibers during the production thereof by means of processing of sunflower hulls (step (a)).

The term T_{PCmax} is to be understood as meaning the maximum temperature in the mixture during the mixing of the sunflower hull fibers produced in step (a) with the plastics material (step (b)).

The term T_{IM} is to be understood as meaning the temperature of the composite material introduced into the injection mold in a defined section of the injection mold.

As previously noted hereinabove, sunflower hull fibers decompose at temperatures of greater than 200° C. The decomposition process increases with increasing temperature in terms of rate and in terms of extent of decomposition. The greater the difference AT between the temperature T_{IM} in at least one section of the injection mold and the higher of the two temperatures T_{PFmax} and T_{PCmax}, the more distinctive the effect imparted in the at least one section of the injection mold by the use of the sunflower hull fibers produced under gentle conditions. It has been found in the applicant's own investigations that even a temperature difference ΔT>20° C. often brings about an effect which is surprising and convincing from the perspective of a person skilled in the art, in particular in terms of reduction of incidences of shrinkage (in particular sink marks). The effects are particularly distinct from a temperature difference ΔT>40° C.

It will be appreciated that the difference ΔT based on at least one section of the injection mold is always greater than 20° C. when neither of the values T_{PFmax} and T_{PCmax} is greater than 180° C., because the temperature T_{IM} (as defined above) is always greater than 200° C. in at least one section of the injection mold.

Conversely, the difference ΔT based on at least one section of the injection mold is also always greater than 20° C. when in this at least one section of the injection mold in step (c) a temperature T_{IM} (as defined above) of greater than 220° C. prevails.

Analogous considerations apply for the preferred difference ΔT of greater than 40° C.

It is particularly preferable when in step (c) of a method according to the invention the composite material introduced into the injection mold has a temperature T_{IM} of greater than 220° C., preferably of greater than 240° C., in at least one section of the injection mold. As previously indicated hereinabove, in individual cases the person skilled in the art will choose temperatures which make it possible to achieve the desired effect in simple fashion using the resources available. In many cases it is equally possible to achieve a desired effect with a comparatively small amount of employed sunflower hull fibers by means of a particularly high temperature T_{IM} in at least one section of the injection mold as it is to achieve the desired effect when using comparatively large amounts of sunflower hull fibers and a comparatively low temperature T_{IM} in this very section of the injection mold.

Provided that the injection mold has one or more sections which define(s) a wall thickness of the product of 4 mm or more, it is particularly advantageous when the composite material introduced into the injection mold (in step (c)) has a temperature T_{IM} of greater than 200° C. in at least one of these sections of the injection mold. As previously elucidated hereinabove, particularly regions of injection molded products having a wall thickness of 4 mm or more are susceptible to incidences of shrinkage and sink marks. Step (c) of a method according to the invention preferably ensures that particularly in sections of the injection mold that define such a wall thickness of the product, at least sectionwise a temperature T_{IM} of greater than 200° C. is achieved.

In a method according to the invention the injection molded product preferably comprises a semicrystalline thermoplastic. As previously elucidated hereinabove, the use of plastics materials which during hardening can form crystalline regions has in practice to date very often resulted in undesired incidences of shrinkage and sink marks. In the context of the present invention, particularly marked improvements in the production of precisely such injection molded products which comprise a semicrystalline thermoplastic are achieved. According to the invention it is not necessary, but not precluded either, that molded composite materials (product of step (c) of a method according to the invention) be cooled particularly rapidly to prevent the formation of crystalline regions in the resulting product. On the contrary the applicant's own investigations have revealed that the heat of crystallization liberated during crystallization advantageously promotes the release of (additional) gases from the employed sunflower hull fibers.

Although particularly good results are achieved when the injection molded product of the method according to the invention comprises a semicrystalline thermoplastic, the use of such plastics materials which do not form crystalline regions upon the solidification in the method according to the invention is not entirely precluded. On the contrary, the use of the method according to the invention has also proven advantageous for so-called amorphous plastics materials such as acrylonitrile-butadiene-styrene (ABS).

Methods according to the invention where the injection molded product comprises a semicrystalline thermoplastic formed from the group consisting of polypropylene (PP), polyethylene (PE) and polylactic acid (PLA) are particularly preferred.

The use of other plastics materials which result in semicrystalline thermoplastics is likewise preferred. Preferred in this respect are the plastics polyoxymethylene (POM), polyamide (PA), polyethylene terephthalate (PET), polybutylene terephthalate (PBT) and polytetrafluoroethylene (PTFE).

Provided that the injection molded product in preferred embodiments of the method according to the invention comprises (i) a semicrystalline thermoplastic, it typically also comprises (ii) bubbles generated by gases liberated from the sunflower hull fibers in step (c). It has been found in investigations of corresponding injection molded products that the volume occupied by bubbles is consistently particularly large in sections of the injection molded product which correspond to sections of the injection mold in which particularly high temperatures T_{IM} (as defined above) prevailed during performance of the method (step (c)).

In a method according to the invention in which the injection molded product comprises a semicrystalline thermoplastic, preferably in preferred embodiments of such a method, in step (a) the maximum temperature T_{PFmax} of less than 200° C. is preferably chosen in such a way, and in step (b) the maximum temperature T_{PCmax} of less than 200° C. is preferably chosen in such a way and in step (b) the sunflower hull fibers are preferably also employed in such an amount that the injection molded product has a shrinkage of less than 1.8%, preferably of less than 1.5%, particularly preferably of less than 1.0%.

Shrinkage is to be calculated here according to the following formula:

Shrinkage=100%×(size of injection mold−size of injection molded product)/size of injection mold

In preferred methods according to the invention step (a) comprises drying the sunflower hulls and/or the sunflower hull fibers. Typically the sunflower hulls and/or the sunflower hull fibers are subjected to a heat treatment for drying, but according to the invention the condition that the maximum temperature T_{PFmax} is less than 200° C. still applies. For preferred embodiments reference is made to what is noted hereinabove. For the aspect of drying to a desired water content reference is made to the document WO 2013/072146 and to the document WO 2014/184273.

The invention also relates to an injection molded product producible by a production method according to the invention as defined hereinabove. Such an injection molded product may be consistently identified by the presence of characteristic bubbles present in particular in proximity to embedded sunflower hull fibers and in sections in which the temperature of the composite material in step (c) of the method according to the invention was particularly high. Performance of above-specified preferred embodiments of a production method according to the invention results in further characteristic product properties.

Injection molded products according to the invention are particularly suitable for use as elements of furniture, buildings and building accessories.

The invention also relates to the use of sunflower hull fibers prepared from sunflower hulls at a maximum temperature T_{PFmax} of less than 200° C. as an additive in an injection moldable composite material for reducing shrinkage in automatic injection molding of the composite material into an injection mold. In terms of preferred embodiments of such a use the elucidations specified for the method according to the invention apply accordingly.

In the context of the use according to the invention the product of method step (a) of the method according to the invention is employed as an additive and serves to reduce shrinkage during automatic injection molding.

This aspect of the invention is based on the surprising finding that sunflower hull fibers prepared in this way provide very special properties and contribute to the specific establishment of desired product properties. Reference is made to the detailed explanations above.

Preference is given to a use according to the invention, wherein during automatic injection molding a temperature T_{IM} of the composite material of greater than 200° C. prevails in at least one section of the injection mold. Regarding the effects associated therewith and regarding preferred embodiments reference is made to what is noted above concerning the method according to the invention.

Preference is given to a use according to the invention, wherein sunflower hull fibers which liberate gases at a temperature of greater than 200° C. are employed as an additive. This means that the employed sunflower hull fibers liberate gases and form bubbles anywhere in the injection mold where the temperature T_{IM} of the composite material is greater than 200° C.

The invention is more particularly elucidated hereinbelow with reference to an example:

Two composites (composite 1 and composite 2) were produced having respective formulations differing only in the manner of preparation of the respectively employed sunflower hull fibers. Composite 1 is for performing an inventive example; composite 2 is for performing a noninventive example.

The formulation of the composites 1 and 2 is reported below (weight percentages are based on the total weight of the mixture):
63.7 wt % polypropylene copolymer (commercial product, Borealis)
35 wt % sunflower hull fibers (different preparation for composites 1 and 2, see below)
1 wt % adhesion promoter (Licocene PP MA 7452 GR TP)
0.2 wt % process stabilizer (Irgafos 168)
0.1 wt % heat stabilizer (Irganox 1076)

Composite 1 comprises sunflower hull fibers produced from sunflower hulls in compliance with the requirements of method step (a) of the method according to the invention, namely at a maximum processing temperature T_{PFmax} of 195° C.

Composite 1 was produced in compliance with method step (b) of the method according to the invention, by mixing the sunflower fibers produced in step (a) with the above-reported further formulation constituents of the composite (polypropylene copolymer, adhesion promoter prozess stabilizer, heat stabilizer). The mixing temperature here was likewise 195° C.

The thus produced injection moldable composite material “composite 1” was automatically injected into an injection mold having a cuboidal cavity to afford an injection molded block.

The composite material “composite 1” introduced into the injection mold had a temperature T_{IM} of about 220° C. at least in individual sections of the injection mold (cuboidal cavity).

The molded composite material “composite 1” was removed from the injection mold as a finished injection molded product and the dimensions (height, width, length) of the approximately cuboidal injection molded product were determined.

The corresponding investigation was repeated five-fold (examples 1.1 to 1.5). The mean value of the respective measurements and the individual measurements are reported in table 1 which follows.

Investigations for “composite 2” were performed in analogous fashion. All parameters for the investigation were identical to those reported hereinabove for “composite 1”, with a single exception:

Composite 2 comprises sunflower hull fibers produced from sunflower hulls in noncompliance with the requirements of method step (a) of the method according to the invention at a maximum processing temperature T_{PFmax} of 220° C.

For composite 2 as well, the measurements recited for composite 1 were performed and mean values determined. The results are reported in the table which follows.

The table which follows comprises a block “comparison” in which the mean values for “composite 1” and “composite 2” are entered. An additional column reports the “shrinkage difference in spatial dimension concerned”, i.e. the difference between the respective “composite 1 mean value” and the respective “composite 2 mean value”. It has been found that “composite 1” has a greater mean value in every spatial direction and “composite 2” in comparison has a smaller mean value in each case. This indicates that “composite 2” afforded an injection molded product which was subject to a more severe shrinkage on cooling; the procedure for composite 2 and the thus obtained injection molded product are not inventive.

The column “shrinkage in spatial dimension concerned/%” completes table 1; this reports the respective shrinkage in comparison of “composite 2” with “composite 1”. The reported shrinkage values were calculated by the following formula:

Shrinkage in spatial dimension concerned=100%×(mean value for composite 1 in spatial dimension concerned−mean value for composite 2 in spatial dimension concerned)/mean value for composite 2 in spatial dimension concerned

In conclusion it must be noted that for the inventive procedure, i.e. when using composite 1, injection molded blocks were obtained which were subject to a lower shrinkage compared to a noninventive procedure, i.e. when using composite 2.

TABLE 1

| | Composite 1 (inventive) | | | | | |
|---|---|---|---|---|---|---|
| | Example | Example | Example | Example | Example | Mean |
| | 1.1 | 1.2 | 1.3 | 1.4 | 1.5 | value |
| Height/mm | 20.1 | 20.1 | 19.9 | 20.2 | 20.2 | 20.10 |
| Width/mm | 29.8 | 29.5 | 29.85 | 29.9 | 29.5 | 29.71 |
| Length/mm | 79.5 | 79.1 | 79.5 | 79.65 | 79.1 | 79.37 |

T_{PFmax} (in step (a)): 195° C.

| | Composite 2 (noninventive) | | | | | |
|---|---|---|---|---|---|---|
| | Example | Example | Example | Example | Example | Mean |
| | 2.1 | 2.2 | 2.3 | 2.4 | 2.5 | value |
| Height/mm | 19.7 | 19.9 | 19.8 | 20.0 | 20.0 | 19.88 |
| Width/mm | 28.9 | 29.2 | 28.9 | 29.2 | 29.25 | 29.09 |
| Length/mm | 78.4 | 78.65 | 78.45 | 78.75 | 78.7 | 78.59 |

T_{PFmax} (in step (a)): 220° C.

| | Comparison | | | |
|---|---|---|---|---|
| | | | Shrinkage difference | Shrinkage in |
| | Composite 1 | Composite 2 | in spatial | spatial dimension |
| | mean value | mean value | dimension concerned | concerned/% |
| Height/mm | 20.10 | 19.88 | 0.22 | 1.11 |
| Width/mm | 29.71 | 29.09 | 0.62 | 2.13 |
| Length/mm | 79.37 | 78.59 | 0.78 | 0.99 |

In the present application wall thickness is to be understood as being equivalent to walling thickness, the term packing pressure is to be understood as being equivalent to holding pressure and the term compression time is to be understood as being equivalent to holding pressure time.

As previously noted in the introduction to the description, the applicant's own investigations have shown that, surprisingly, at a temperature of 200° C. or more an irreversible decomposition of constituents of sunflower hull fibers takes place which results in the liberation of gases on a considerable scale.

In a table which follows this is also shown in quantitative fashion, wherein for a particular temperature value the table shows an accompanying value for absolute emission and—even more importantly—a relative emission based on 180° C., wherein the values for relative emission are normalized to the value 180° C. (relative emission at 180° C. is therefore at the normal value 1):

Relative change in gas emission as a function of the
temperature of sunflower hulls based on emission at 180° C.

| | | Relative emission |
|---|---|---|
| Temperature/ | Absolute | based on 180° C. |
| ° C. | emission | (normalized) |
| 180 | 0.34 | 1.00 |
| 190 | 2.88 | 8.47 |
| 200 | 4.29 | 12.62 |
| 210 | 5.86 | 17.24 |
| 220 | 10.98 | 32.29 |

To perform this investigation the following experimental set up was used:

Around 25 mg of a respective sample (sunflower biopolymer composite) were desorbed directly for 15 minutes at 180° C., 190° C., 200° C., 210° C. and 220° C. on a Markes TD100 instrument and the emissions captured on a cooling surface and concentrated. Also, around 1 g of the sample was initially charged into a 20 mL headspace vial, this was subjected to thermal stress at 200° C. for 15 minutes and subsequently the headspace was sampled using a gas-tight syringe (150° C., 250 μL). The emissions of both sampling types were analyzed by GC-MS, a shorter column (30 m) being used in the headspace measurement for system reasons.

Evaluation of Results:

Rising desorption temperature has only a very slight influence on the hydrocarbon emissions originating from the polypropylene (PP) used (peak groups from about 25 min onward). The concentration thereof is relatively constant for all samples wherein at higher desorption temperatures there is an increase in the higher molecular weight hydrocarbons. At 180° C. and 190° C. only slight additional emissions were detectable but from 200° C. a marked increase in emitted substances was detectable. This is attributable in particular to the degassing of the sunflower hull fiber constituents, in particular to the longer-chain fatty acids still present in the hull fibers which desorb from the sample at these temperatures. Calculating the proportion of measured total emissions between 0 min and 25 min using a sum integral gives 0.34% at 180° C., 2.88% at 190° C., 4.29% at 200° C., 5.86% at 210° C. and finally around 10.98% at 220° C. The emissions of volatile, low molecular weight substances thus increase by a factor of more than 30 between 180° C. and 220° C.

The emissions very likely originate from the decomposition of the biomass (sunflower hull fibers). In addition to the expected hemicellulose decomposition products such as acetic acid, furfural and hydroxymethyl furfural, at 210° C. and 220° C. substances such as vanillin, coniferyl aldehyde and coniferyl alcohol, which may be formed during depolymerization of lignin, were also detectable. The increase in the desorption temperature from 180° C. to 220° C. results in around 15-fold higher acetic acid emissions and the furfural emissions increased by a factor of 40. Emissions of sulfur-containing compounds and pyrrole derivatives were also demonstrated in small amounts.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A method for producing an injection molded product, comprising the steps of:
(a) processing sunflower hulls into sunflower hull fibers at a maximum temperature T_{PFmax} of less than 200° C;
(b) producing an injection moldable composite material by mixing the sunflower hull fibers produced in step (a) with a plastics material at a maximum temperature T_{PCmax} of less than 200° C.;
(c) automatically injection molding the produced injection moldable composite material into an injection mold to obtain a molded composite material, wherein where the composite material introduced into the injection mold has a temperature T_{IM} of greater than 200° C. in at least one section of the injection mold; and
(d) demolding the molded composite material to obtain the injection molded product.

2. The method as claimed in claim 1;
wherein the difference ΔT between the temperature T_{IM} and the higher of the two temperatures T_{PFmax} and T_{PCmax} is greater than 20° C.

3. The method as claimed in claim 1;
wherein the at least one section of the injection mold, into which the composite material having the temperature T_{IM} of greater than 200° C. is introduced, defines a wall thickness of the product of 4 mm or more.

4. The method as claimed in claim 1;
wherein the injection molded product comprises a semicrystalline thermoplastic.

5. The method as claimed in claim 1;
wherein the injection molded product comprises a semicrystalline thermoplastic selected from the group consisting of polypropylene (PP), polyethylene (PE), and polylactic acid (PLA).

6. The method as claimed in claim 4;
wherein the injection molded product further comprises bubbles generated by gases liberated from the sunflower hull fibers in step (c).

7. The method as claimed in claim 1;
wherein step (a) comprises drying the sunflower hulls, the sunflower hull fibers, or both.

8. An injection molded product produced by the production method according to claim 1.

9. A method comprising:
utilizing sunflower hull fibers prepared from sunflower hulls at a maximum temperature T_{PFmax} of less than 200° C. as an additive in an injection moldable composite material to reduce shrinkage in automatic injection molding of the composite material into an injection mold.

10. The method as claimed in claim 10;
wherein, during automatic injection molding, the composite materiai has a temperature T_{IM} of greater than 200° C. in at least one section of the injection mold.
